(19) United States
(12) Patent Application Publication
(10) Pub. No.: US 2004/0039577 A1
(43) Pub. Date: Feb. 26, 2004

(54) Motor vehicle data collection system

(76) Inventors: Douglas W. Roan, Wake Forest, NC (US); Robbie S. Womack, Apex, NC (US)

Correspondence Address: GREGORY STEPHENS, MOORE & VAN ALLEN, SUITE 800, 2200 WEST MAIN STREET, DURHAM, NC, 27705, US

(21) Appl. No.: 10/173,294

(22) Filed: Jun. 17, 2002

(51) Int. Cl. G06F 17/60

(52) U.S. Cl. 705/1; 348/143

(57) ABSTRACT

A system and method for use in motor vehicle service facilities that deters theft of services. A motor vehicle is detected through the use of a cooperating pair of pressure sensors. The pressure sensors are positioned such that the tires of the motor vehicle roll over the pressure sensors as the motor vehicle enters a bay area for service work. A camera situated in the bay area is coupled with the sensors and takes a time-stamped photo of any motor vehicle that triggers the sensors. In order to reduce the number of false positive triggering events, the camera will only take a photo if both sensors are triggered within a predetermined time of one another. The photos are time-stamped and archived for later auditing purposes. The photos are used in conjunction with invoice data for services provided. A computer system reconciles the number of invoices against the number of photos. If a discrepancy is found, a comparison is made between the time-stamp on the invoices and the time-stamp on the photos. Photos without corresponding invoices are flagged for further investigation.

### BACKGROUND OF THE INVENTION

The present invention relates to motor vehicle data collection in connection with motor vehicle services in order to reconcile a number of vehicles serviced with a number of invoices for the vehicles serviced.

In the past, corner service stations offered gasoline and limited motor vehicle services and repairs. Such services and repairs were comprised of oil changes, tune-ups, mufflers, and other relatively simple maintenance services. The demise of the traditional service station has led to a corresponding rise in high volume auto service centers that usually focus on providing one of these services, such as quick oil change and lubrication centers and muffler shops.

A serious problem faced by the owners of such service centers is revenue theft by employees. Revenue theft typically occurs when a service is performed but no invoice is created for the service. This new industry has mostly developed around franchises and/or multi-store chains that service a large number of vehicles in a day. Thus, a premium is placed on having an effective accounting system for detecting revenue theft by employees. In addition, much of the revenue generated is from services, so inventory based accounting safeguards are ineffective at detecting and preventing employee revenue theft. Point-of-sale (POS) accounting systems for the industry are becoming more sophisticated in their attempts to detect and prevent revenue theft. However, dishonest employees routinely circumvent the POS system safeguards by simply not entering a transaction into the system, opting to take cash for a given transaction instead.

The automated drive-through car wash industry has employed various triggering mechanisms designed to “count” the number of cars it services. Unfortunately, these mechanisms are not suitable for use in the new auto service industry. Factors such as building design and operational differences render the car wash systems problematic for use in the new auto service industry. The most significant drawback is the inadvertent triggering of an event. With respect to the new auto service industry, an event can be characterized as a motor vehicle pulling into a service bay in anticipation of being serviced in some manner. The problem with having too many inadvertent event triggers is that it places a greater burden on reconciling the triggering events with the POS data. Moreover, unscrupulous employees can claim that a discrepancy is the result of a false trigger rather than revenue theft. False triggers are not generally a problem for the car wash industry because the triggering sensors can be placed in areas that employees would have a very difficult time triggering such as within the automated portion of the car wash system.

What is needed is a physical system that can not be circumvented and that can be linked and cross-referenced with an invoice system in order to monitor and track the activities in and around a motor vehicle service area.

### SUMMARY

The present invention comprises a system and method for use in automotive service facilities that detects and records the entry of a motor vehicle into a service bay for service work. The motor vehicle is detected through the use of a cooperating pair of pressure sensors. The pressure sensors are positioned such that the tires of the motor vehicle roll over the pressure sensors as the motor vehicle enters a service bay area for service work. A camera situated in the bay area is coupled with the sensors and takes a time-stamped photo of any motor vehicle that triggers the sensors. In order to reduce the number of false positive triggering events, the camera will only take a photo if both sensors are triggered within a predetermined time of one another (nearly simultaneous). The photo is time-stamped and archived for later auditing purposes. The photos are used in conjunction with an accounting point-of-sale (POS) data collection system that tracks invoices for services provided. A computer system reconciles the number of invoices against the number of photos. If a discrepancy is found, a comparison is made between the time-stamp on the invoices and the time-stamp on the photos. Time-stamped photos without corresponding time-stamped invoices are flagged for further investigation.

### BRIEF DESCRIPTION OF THE DRAWINGS

FIG. 1 is a perspective block diagram of a service bay area implementing the present invention.

FIG. 2 is a functional block diagram of components that comprise the present invention.

FIG. 3 is a functional block diagram of components that comprise an alternative embodiment of the present invention.

FIG. 4 is a flowchart tracking the data flow of the present invention.

### DETAILED DESCRIPTION OF THE INVENTION

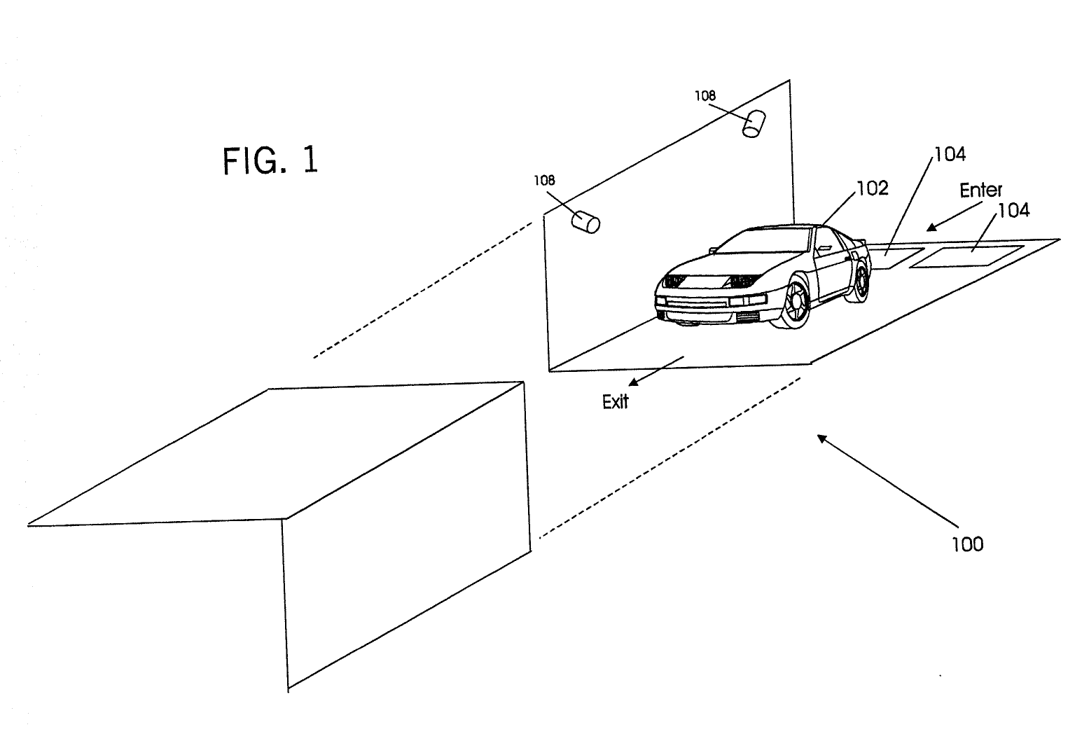

FIG. 1 illustrates a typical automobile service bay 100 in which a motor vehicle 102 typically enters at one end of the service bay area 100 and is parked. The service bay area 100 can include a hydraulic system for lifting the motor vehicle 102. Upon completion of service, the motor vehicle 102 exits the service bay area 100. The present invention incorporates a sensor system 104 coupled with a counter (not shown) and/or camera system 108 physically located within or near the service bay area 100. The sensors 104 are positioned at the entrance of the service bay area 100 such that a motor vehicle 102 must cross over them with each front tire upon entering the service bay area 100. This triggers the counter system (not shown) to increment its count of vehicles serviced for the day. It also triggers the camera system 104 causing one or more digital photos to be taken of the motor vehicle 102 that just entered the service bay area 100. In order to significantly reduce or eliminate any false triggers, both sensors must be triggered in a near simultaneous time-frame.

Other sensor types and configurations are possible depending on the physical layout of a motor vehicle service station. For instance, image recognition sensors, rather than pressure sensors, may be used to detect the presence of a motor vehicle entering a service bay area. Moreover, sensors may be placed at other locations besides the floor of the entrance to the service bay area. Thus, the configuration described above is illustrative in nature and not intended to limit the present invention to a particular configuration or sensor type. One of ordinary skill in the art could easily conceive of alternative configurations without departing from the spirit or scope of the present invention.

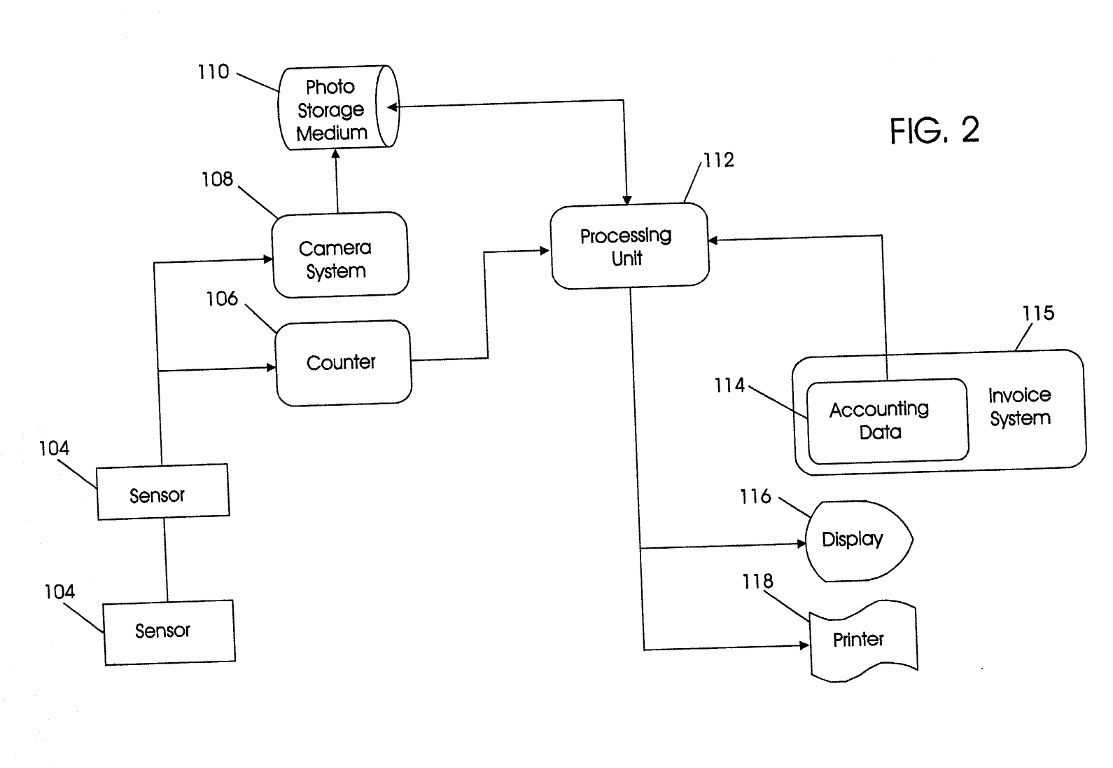

FIG. 2 details the functional operation of various components that comprise the present invention. FIG. 2 is shown as a stand-alone architecture, one in which the auditing processing occurs on-site.

A pair of sensors 104 are coupled such that they can only be triggered when a certain downward force is exerted on both sensors 104 nearly simultaneously. This typically occurs when a motor vehicle 102 is driven across the sensors 104 upon entering a service bay area 100. By requiring both sensors 104 to be nearly simultaneously activated, the present invention significantly reduces the occurrences of false triggers. The sensors are electrically coupled with either a counter mechanism 106, a camera system 108, or both. The coupling between the sensors and the counter 106 or camera system 108 can be either hard-wired or wireless. If wireless, there are a number of infrared (IR) or radio frequency (RF) implementations that can be utilized.

If a counter mechanism 106 is implemented it is reset to zero at the start of the day. Each time the sensors 104 are triggered the counter 106 increments by one thereby keeping a running total of the number of motor vehicles 102 serviced for that day (or other user defined period, i.e., week, month).

If a camera system 108 is implemented, then a photo (typically digital) is taken of the service bay area 100 when the sensors 104 are triggered. The photo captures an image of a motor vehicle 102 that has entered the service bay area 100. The photos are stored in a photo storage medium 110 that is coupled with the camera system 108. Typically, the captured image readily conveys the make and model of the motor vehicle that has entered the service bay area 100 as well as other unique identifying characteristics that can be cross-referenced against data on an invoice.

The counter mechanism 106 and photo storage medium 110 are coupled with a processing unit 112. The processing unit 112 is further coupled with and has access to accounting data 114. The accounting data typically is created by a point-of-sale (POS) computer invoice system that is used to invoice customers. The POS system may be, but need not be, resident in processing unit 112. Processor 112 compares the counter data (or number of photos taken) against the number of invoices generated by the POS software over a given period. The numbers should match exactly. If there is not a match, then an auditing process is undertaken. Processor 112 is also coupled with output devices such as a display 116 and/or a printer 118. The display 116 and/or printer 118 provide a means for producing audit results to a human operator.

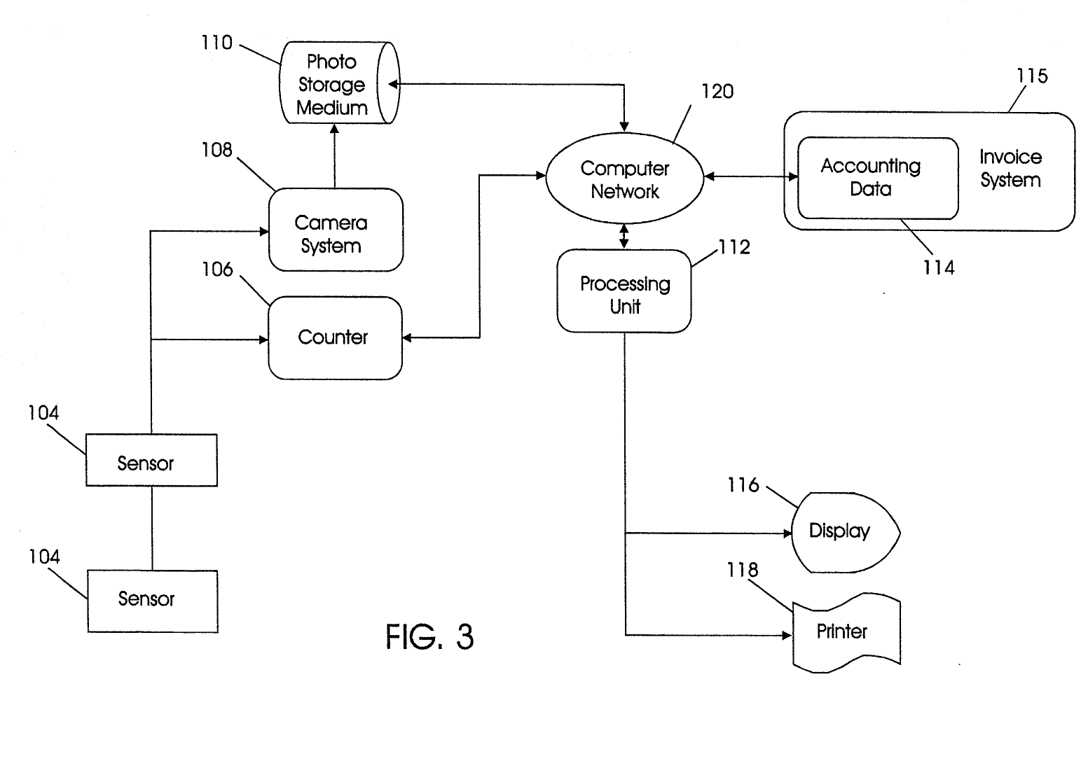

FIG. 3 details the functional operation of various components that comprise an alternate embodiment of the present invention. FIG. 3 is shown as a network architecture, one in which the auditing processing occurs at a remote location with respect to the counter mechanism 106, photo storage medium 110, and accounting data 114. The components of FIG. 3 function the same as described for FIG. 2. The chief difference is that the back end processing functions (processor 112, accounting data 114) are physically decoupled from the front end data gathering components (sensors 104, counter 106, camera 108, photo storage medium 110). A computer network 120 now separates the physical data gathering components from processor 112. This permits the data processing functions to be centralized at a remote location. In addition, while it is not shown in FIG. 3, multiple sensor/counter/camera systems may be connected to computer network 120. Moreover, computer network 120 can be a private network or a public network such as the Internet. Remote processing is highly desirable when a single entity owns a plurality of motor vehicle service stations and wishes to audit each from a central location.

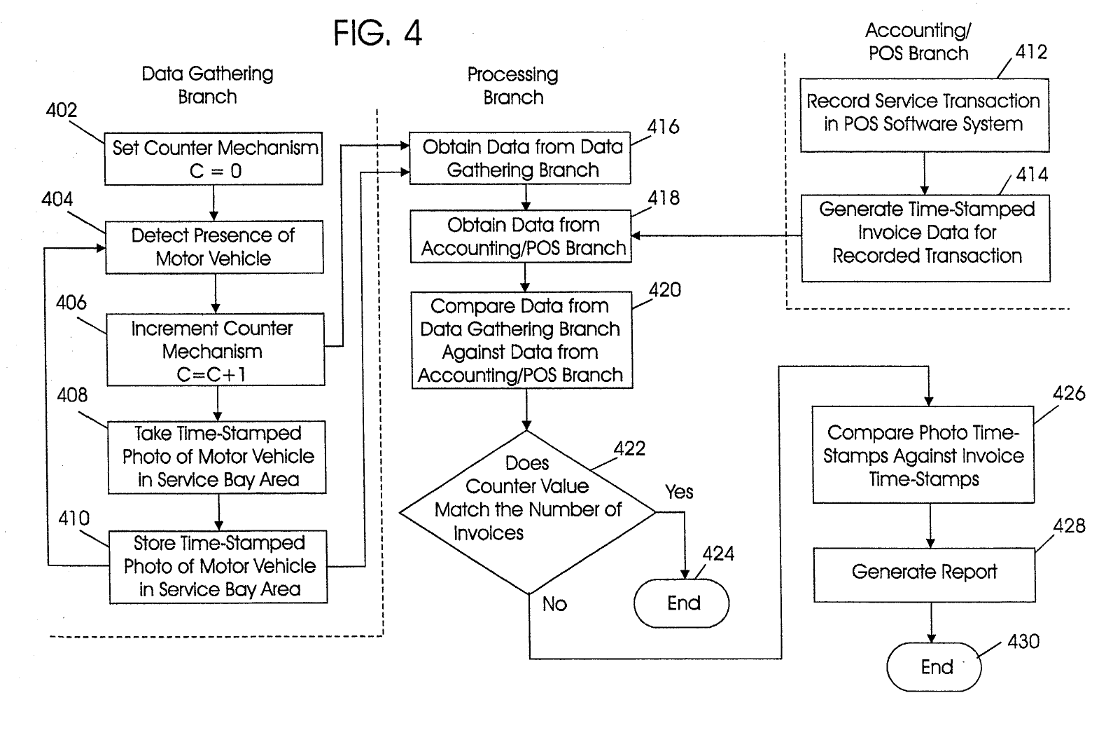

FIG. 4 is a flowchart tracking the data flow among the components that comprise the present invention. The present invention can be logically divided into three separate branches, a data gathering branch, an accounting/POS branch, and a processing branch. The data gathering branch is comprised of the sensors, counter mechanism, camera system, and photo storage medium. The accounting/POS branch is comprised of the accounting data and its POS associated computer system. The processing branch is comprised of the processing unit and its input/output devices and serves as a link between the data gathering and accounting/POS branches.

The data gathering branch initially sets the counter mechanism to zero 402 to signify the beginning of a new period. A period can be a day, a week, a month, or some other user-defined interval. No data is gathered until sensors detect the presence of a motor vehicle 404. Once a motor vehicle is detected in a service bay area, the counter mechanism is incremented by one 406 and a time-stamped photo of the service bay area is taken 408. The photo can be taken by a single camera or by multiple cameras. The purpose of the photo is to provide visual time-stamped information as to the make and model of the motor vehicle that has entered the service bay. The time-stamped photo(s) are then archived in a photo storage medium 410. Control of the data gathering process is then looped back to an idle state of waiting to detect the presence of another motor vehicle 404 entering a service bay area.

The accounting/POS branch is typically a separate computer system that generates and tracks invoices for services performed on motor vehicles. Its primary functions are to record a service transaction 412 and generate time-stamped invoice data for the recorded transaction 414. The invoice should contain data pertaining to the make and model of the motor vehicle in addition to other routine invoice data.

The processing branch is coupled with both the data gathering branch and the accounting/POS branch. The processing branch obtains time-stamped counter and photo data from the data gathering branch 416. The processing branch also obtains invoice data from the accounting/POS branch 418. The counter data from the data gathering branch is compared against the number of invoices from the accounting/POS branch 420. A check is performed to determine if the counter data and invoice data match 422. If the number of invoices matches the counter number (or number of photos), then there are no discrepancies and the process is terminated 424. Otherwise, an audit procedure is initiated. The first step of the audit procedure is to compare the time-stamped photos against the time-stamped invoices 426. With respect to each individual bay, there should be a photo time-stamp preceding (by a user-definable interval) a corresponding invoice time-stamp for a given motor vehicle. A problem will arise when there is no corresponding invoice for a time-stamped photo. Whenever, a mismatch occurs a report is generated 428 by the processing unit.

The report is typically comprised of a list of time-stamped photos that show the make and model of the motor vehicle and a list of invoices containing the make and model of the motor vehicle as entered on the invoice. The report may be displayed, printed, or otherwise output in human readable form. Determining affirmative matches between photos and invoices involves comparing each photo in the report against the invoice data in the report to determine which photo(s) do not have corresponding invoices.

Specific embodiments of an invention are described herein. One of ordinary skill in the art will quickly recognize that the invention has other applications in other environments. In fact, many embodiments and implementations are possible. The appended claims are not intended to limit the scope of the invention to the specific embodiments described above.

1. A method of preventing revenue theft in a motor vehicle service business comprising:
detecting, as an event, the presence of a motor vehicle in a motor vehicle service bay;
recording the event of the presence of said motor vehicle in said motor vehicle service bay;
time-stamping the recorded event of the presence of said motor vehicle in said motor vehicle service bay;
comparing the time-stamped recorded events against a corresponding set of time-stamped invoices; and
determining if there are any discrepancies between the time-stamped recorded events and the time-stamped invoices.

2. The method of claim 1 further comprising generating a report detailing any discrepancies between the time-stamped recorded events and the time-stamped invoices.

3. The method of claim 2 in which the report is a printed report including a set of time-stamped invoices and a corresponding set of time-stamped photos.

4. The method of claim 2 in which the report is a visual display including a set of time-stamped invoices and a corresponding set of time-stamped photos.

5. The method of claim 1 wherein said recording comprises taking a photo of the motor vehicle service bay upon the motor vehicle triggering pressure sensors as the motor vehicle moves into the motor vehicle service bay.

6. The method of claim 1 wherein said recording comprises incrementing a counter mechanism upon the motor vehicle triggering pressure sensors as the motor vehicle moves into the motor vehicle service bay.

7. The method of claim 5 wherein said pressure sensors are oriented such that each front tire of a motor vehicle entering a service bay area will contact a corresponding pressure sensor nearly simultaneously.

8. A system for preventing revenue theft in a motor vehicle service business comprising:
a physical detection subsystem that detects the presence of a motor vehicle in a service bay area;
an event recordation subsystem coupled with the physical detection subsystem that time-stamps and records the detection of a motor vehicle in a service bay area;
an invoice subsystem that generates time-stamped invoice data pertaining to motor vehicle services provided; and
a processing subsystem coupled with the event recordation subsystem and the invoice subsystem that compares data from the event recordation subsystem with data from the invoice subsystem in order to determine whether the number of motor vehicles recorded by the event recordation subsystem matches the number of invoices generated by the invoice subsystem.

9. The system of claim 8 wherein the physical detection subsystem comprises pressure sensors oriented at the entrance of the service bay area such that each front tire of a motor vehicle entering the service bay area contacts a corresponding pressure sensor nearly simultaneously thereby causing a triggering event.

10. The system of claim 9 wherein the event recordation subsystem comprises a first camera coupled with the pressure sensors such that the first camera will take a photo of the motor vehicle entering the service bay area upon the triggering event.

11. The system of claim 10 wherein the event recordation subsystem further comprises a second camera coupled with the pressure sensors such that the second camera will take a photo of the motor vehicle entering the service bay area upon the triggering event from a different perspective than the first camera.

12. The system of claim 9 wherein the event recordation subsystem comprises a counter mechanism coupled with the pressure sensors such that the counter mechanism will increment a count upon the triggering event.

13. The system of claim 10 wherein the processing subsystem comprises:
a processor that:
compares the time-stamped photos against a corresponding set of time-stamped invoices; and
determines if there are any discrepancies between the time-stamped recorded photos and the corresponding set of time-stamped invoices.

14. The system of claim 13 wherein invoice data includes the make and model of the motor vehicle serviced.

15. The system of claim 14 further comprising generating a report detailing any discrepancies between the time-stamped recorded events and the time-stamped invoices.

16. The system of claim 15 in which the report is a printed report including a set of time-stamped invoices and a corresponding set of time-stamped photos.

17. The system of claim 15 in which the report includes a visual display including a set of time-stamped invoices and a corresponding set of time-stamped photos.

18. The system of claim 10 wherein the processing subsystem is coupled with the event recordation subsystem and the invoice subsystem by means of a computer network such that the processing subsystem can remotely access the data from the event recordation subsystem and the invoice subsystem.
